(19) United States
(12) Patent Application Publication
(10) Pub. No.: US 2021/0179782 A1
(43) Pub. Date: Jun. 17, 2021

(54) Powder Bed Fusion Printing System Employing A Polyarylene Sulfide Powder

(71) Applicant: Ticona LLC, Florence, KY (US)

(72) Inventors: Craig J. Peterson, Hebron, KY (US); Xinyu Zhao, Cincinnati, OH (US); Yuehua Yu, Cincinnati, OH (US)

(21) Appl. No.: 17/120,358

(22) Filed: Dec. 14, 2020

Related U.S. Application Data
(60) Provisional application No. 62/948,872, filed on Dec. 17, 2019.

(51) Int. Cl. C08G 75/14; B33Y 10/00; B33Y 30/00; B33Y 70/00; B29C 64/153

(52) U.S. Cl. CPC C08G 75/14; B33Y 10/00; B29K 2081/04; B33Y 70/00; B29C 64/153; B33Y 30/00

(57) ABSTRACT

A three-dimensional printing method is provided. The method comprises selectively fusing a powder within a powder bed, wherein the powder comprises a plurality of polyarylene sulfide microparticles having a volume-based median particle size of from about 0.5 to about 200 micrometers.

### RELATED APPLICATION

The present application claims priority to U.S. Provisional Application Ser. No. 62/948,872, filed on Dec. 17, 2019, which is incorporated herein in its entirety by reference thereto.

### BACKGROUND OF THE INVENTION

Powder bed fusion (e.g., selective laser sintering) is a three-dimensional printing system that has been commonly used to form various three-dimensional structures. Unfortunately, its use has still been somewhat limited in advanced product applications that require a higher level of material performance, such as high thermal stability and heat resistance, enhanced flow, and good mechanical properties. One reason for this limitation is that the polymeric materials commonly employed in powder bed fusion generally lack high performance properties. Conversely, attempts at employing high performance polymers have often failed as such polymers tend to lack the requisite properties required for the powder bed fusion process. As such, a need exists for a high performance powder that can be readily employed in a powder bed fusion printing system.

### SUMMARY OF THE INVENTION

In accordance with one embodiment of the present invention, a three-dimensional printing method is disclosed that comprises selectively fusing a powder within a powder bed to form a three-dimensional structure. The powder comprises a plurality of polyarylene sulfide microparticles having a volume-based median particle size of from about 0.5 to about 200 micrometers. In accordance with still another embodiment of the present invention, a three-dimensional printing system is disclosed that comprises a powder supply comprising a plurality of particles formed from a powder, such as described above; a powder bed configured to receive the powder supply; and an energy source for selectively fusing the powder supply when present within the powder bed.

Other features and aspects of the present invention are set forth in greater detail below.

### BRIEF DESCRIPTION OF THE FIGURE

A full and enabling disclosure of the present invention, including the best mode thereof to one skilled in the art, is set forth more particularly in the remainder of the specification, including reference to the accompanying figure, in which:

FIG. 1 is a schematic view of one embodiment of a powder bed fusion system that may be employed in the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a three-dimensional printing method that involves selectively fusing a powder within a powder bed to form a three-dimensional structure. Notably, the powder comprises a plurality of polyarylene sulfide microparticles having a volume-based median (D50) particle size of from about 0.5 to about 200 micrometers, in some embodiments from about 1 to about 100 micrometers, in some embodiments from about 2 to about 80 micrometers, and in some embodiments, from about 10 to about 50 micrometers, such as determined by laser diffraction. By selectively controlling the specific aspects of the components of the polyarylene sulfide microparticles, the present inventors have discovered that the resulting powder can achieve certain unique properties that allow it to be readily employed in a powder bed fusion system. For example, the particle size distribution may be relatively narrow such that at least 99% by volume (D99) of the microparticles have of about 500 micrometers or less, in some embodiments about 350 micrometers or less, and in some embodiments, about 300 micrometers or less, such as determined by laser diffraction. Further, the particles may also be generally spherical to help improve processability. Such particles may, for example, have an aspect ratio (ratio of length to diameter) of from about 0.7 to about 1.3, in some embodiments from about 0.8 to about 1.2, and in some embodiments, from about 0.9 to about 1.1 (e.g., about 1). Of course, the microparticles may also have other shapes, such as elliptical, polyhedral, disc-like, tubular, fibrous, multi-lobal (e.g., pop-corn like), etc., as well as mixtures of different shapes.

The powder may also exhibit good flow properties. For example, the powder may possess a relatively low melt viscosity, such as about 8,000 poise or less, in some embodiments about 7,000 poise or less, in some embodiments from about 1,000 to about 6,000 poise, in some embodiments from about 2,500 to about 5,500, and in some embodiments, from about 3,000 to about 5,000 poise, as determined by a capillary rheometer at a shear rate of 1,200 seconds⁻¹. Among other things, these viscosity properties can allow the powder to be readily three-dimensionally printed into parts having a small dimension. Due to the relatively low melt viscosity that can be achieved in the present invention, relatively high molecular weight polyarylene sulfides can also be employed with little difficulty. For example, such high molecular weight polyarylene sulfides may have a number average molecular weight of about 14,000 grams per mole (“g/mol”) or more, in some embodiments about 15,000 g/mol or more, and in some embodiments, from about 16,000 g/mol to about 60,000 g/mol, as well as weight average molecular weight of about 35,000 g/mol or more, in some embodiments about 50,000 g/mol or more, and in some embodiments, from about 60,000 g/mol to about 90,000 g/mol, as determined using gel permeation chromatography as described below. One benefit of using such high molecular weight polymers is that they generally have a low chlorine content. In this regard, the resulting powder may have a low chlorine content, such as about 1200 ppm or less, in some embodiments about 900 ppm or less, in some embodiments from 0 to about 800 ppm, and in some embodiments, from about 1 to about 500 ppm.

In addition, the crystallization temperature (prior to three-dimensional printing) of the powder may about 250° C. or less, in some embodiments from about 100° C. to about 245° C., and in some embodiments, from about 150° C. to about 240° C. The melting temperature of the powder may also range from about 250° C. to about 320° C., and in some embodiments, from about 260° C. to about 300° C. The melting and crystallization temperatures may be determined as is well known in the art using differential scanning calorimetry in accordance with ISO Test No. 11357-1:2016. The temperature at which three-dimensional printing may be conducted is typically between the melting temperature and the crystallization temperature. For example, the temperature at which three-dimensional printing may be conducted may be at a temperature from about 200° C. to about 300° C., in some embodiments from about 210° C. to about 290° C., and in some embodiments, from about 225° C. to about 280° C. One particular benefit of the present invention is that the difference between the crystallization and melting temperatures is relatively large, which provides a broad operating window for three-dimensional printing. That is, the operating window is typically from about 10° C. to about 100° C., in some embodiments from about 25° C. to about 75° C., and in some embodiments, from about 40° C. to about 60° C.

Various embodiments of the present invention will now be described in more detail.

### I. Powder

A. Polyarylene Sulfide

Polyarylene sulfides typically constitute from about 25 wt. % to 100 wt. %, in some embodiments from about 30 wt. % to about 100 wt. %, and in some embodiments, from about 40 wt. % to about 90 wt. % of the powder. The polyarylene sulfide(s) employed in the powder generally have repeating units of the formula:

—[(Ar¹)ₙ—X]ₘ—[(Ar²)ᵢ—Y]ⱼ—[(Ar³)ₖ—Z]ᵢ—[(Ar⁴)ₒ—W]ₚ—

wherein,

Ar¹, Ar², Ar³, and Ar⁴ are independently arylene units of 6 to 18 carbon atoms;

W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and

n, m, i, j, k, l, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthylene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene, 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

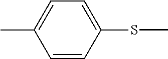

and segments having the structure of formula:

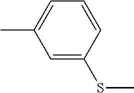

or segments having the structure of formula:

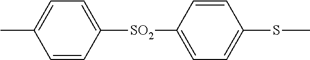

The polyarylene sulfide(s) may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

B. Other Optional Components

If desired, a wide variety of additives can also be included in the powder, such as impact modifiers, fillers, coupling agents, crosslinking agents, nucleating agents, lubricants, flow modifiers, pigments, antioxidants, stabilizers, surfactants, waxes, flame retardants, anti-drip additives, and other materials added to enhance properties and processability. Various optional additives are described below.

i. Impact Modifier

Impact modifiers may optionally constitute from about 1 wt. % to about 40 wt. %, in some embodiments from about 2 wt. % to about 30 wt. %, and in some embodiments, from about 3 wt. % to about 25 wt. % of the powder. Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene, 3,3-dimethyl-1-butene, 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene, 1-dodecene, and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

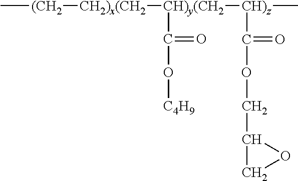

wherein, x, y, and z are 1 or greater.

The relative portion of the monomeric component(s) may be selected to achieve a balance between epoxy-reactivity and melt flow rate. More particularly, high epoxy monomer contents can result in good reactivity with the matrix polymer, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The result melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

One example of a suitable epoxy-functionalized copolymer that may be used in the present invention is commercially available from Arkema under the name LOTADER® AX8840. LOTADER® AX8840, for instance, has a melt flow rate of 5 g/10 min and is a random copolymer of ethylene and a glycidyl methacrylate (monomer content of 8 wt. %). Another suitable copolymer is commercially available from DuPont under the name ELVALOY® PTW, which is a terpolymer of ethylene, butyl acrylate, and glycidyl methacrylate and has a melt flow rate of 12 g/10 min and a glycidyl methacrylate monomer content of 4 wt. % to 5 wt. %.

ii. Crosslinking Agent

If desired, crosslinking agents may also be employed in the powder that can react with chains of the impact modifier to further increase strength. When employed, such crosslinking agents typically constitute from about 0.05 wt. % to about 15 wt. %, in some embodiments from about 0.1 wt. % to about 10 wt. %, and in some embodiments, from about 0.2 wt. % to about 5 wt. % of the powder.

One embodiment such a crosslinking agent is a metal carboxylate. Without intending to be limited by theory, it is believed that the metal atom in the carboxylate can act as a Lewis acid that accepts electrons from the oxygen atom located in the epoxy functional group of the impact modifier. Once it reacts with the carboxylate, the epoxy functional group becomes activated and can be readily attacked at either carbon atom in the three-membered ring via nucleophilic substitution, thereby resulting in crosslinking between the chains of the impact modifier. The metal carboxylate is typically a metal salt of a fatty acid. The metal cation employed in the salt may vary, but is typically a divalent metal, such as calcium, magnesium, lead, barium, strontium, zinc, iron, cadmium, nickel, copper, tin, etc., as well as mixtures thereof. Zinc is particularly suitable. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Metal carboxylates typically constitute from about 0.05 wt. % to about 5 wt. %, in some embodiments from about 0.1 wt. % to about 2 wt. %, and in some embodiments, from about 0.2 wt. % to about 1 wt. % of the powder.

Another suitable crosslinking agent powder is a multi-functional crosslinking agent that generally includes two or more reactively functional terminal moieties linked by a bond or a non-polymeric (non-repeating) linking component. By way of example, the crosslinking agent can include a di-epoxide, poly-functional epoxide, diisocyanate, polyisocyanate, polyhydric alcohol, water-soluble carbodiimide, diamine, diol, diaminoalkane, multi-functional carboxylic acid, diacid halide, etc. Multi-functional carboxylic acids and amines are particularly suitable. Specific examples of multi-functional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized. In certain embodiments, aromatic dicarboxylic acids are particularly suitable, such as isophthalic acid or terephthalic acid.

iii. Flow Modifier

A disulfide compound may also be employed in certain embodiments as a flow modifier. Such compounds can undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the powder. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The manner in which the polyarylene sulfide and other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 50° C. to about 500° C., and in some embodiments, from about 100° C. to about 250° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

Regardless of the optional additives employed, the polyarylene sulfide microparticles can be formed in a variety of ways. In certain embodiments, for instance, the microparticles may be formed by selectively controlling aspects of the process for synthesizing polyarylene sulfides as is known in the art and described, for instance, in U.S. Patent Publication No. 2016/0244569 to Chiond. The microparticles of desired size may also be formed by grinding (e.g., cryogenically grinding) particles of a larger size.

When it is desired to blend other components with the polyarylene sulfide (e.g., impact modifier) to form the powder, various additional techniques may be employed. For example, the microparticles may be formed by heating the polyarylene sulfide and the optional additives in the presence of a solvent to form a mixture, and thereafter cooling the mixture to precipitate microparticles therefrom. In such embodiments, the mixture may be in the form of a solution, suspension, dispersion, etc. Any of a variety of solvents may be employed, such as water, organic solvents, etc. Particularly suitable organic solvent include aprotic solvents, such as halogen-containing solvents (e.g., methylene chloride, 1-chlorobutane, chlorobenzene, 1,1-dichloroethane, 1,2-dichloroethane, chloroform, and 1,1,2,2-tetrachloroethane); ether solvents (e.g., diethyl ether, tetrahydrofuran, and 1,4-dioxane), ketone solvents (e.g., acetone and cyclohexanone); ester solvents (e.g., ethyl acetate); lactone solvents (e.g., butyrolactone); carbonate solvents (e.g., ethylene carbonate and propylene carbonate); amine solvents (e.g., triethylamine and pyridine); nitrile solvents (e.g., acetonitrile and succinonitrile); amide solvents (e.g., N,N′-dimethylformamide, N,N′-dimethylacetamide, tetramethylurea and N-methylpyrrolidone); nitro-containing solvents (e.g., nitromethane and nitrobenzene); sulfide solvents (e.g., dimethylsulfoxide and sulfolane); and so forth. In one embodiment, for example, N-methylpyrrolidone may be employed, either alone or in combination with water. Regardless of the particular solvents employed, the entire solvent system (e.g., N-methylpyrrolidone and water) typically constitutes from about 60 wt. % to about 99 wt. %, in some embodiments from about 70 wt. % to about 98 wt. %, and in some embodiments, from about 75 wt. % to about 95 wt. % of the mixture. The combination of the polyarylene sulfide and impact modifier (e.g., in the form of a masterbatch) may likewise constitute from about 1 wt. % to about 40 wt. %, in some embodiments from about 2 wt. % to about 30 wt. %, and in some embodiments, from about 5 wt. % to about 25 wt. % of the mixture.

In addition to solvent(s), the mixture may also contain inorganic oxide particles. Without intending to be limited by theory, it is believed that such particles can inhibit the likelihood that the resulting microparticles will agglomerate together upon formation, thus allowing the resulting powder to have a relatively fine and consistent size distribution. The inorganic oxide particles may be formed from a variety of materials, including, but not limited to, silica, alumina, zirconia, magnesium oxide, titanium dioxide, iron oxide, zinc oxide, copper oxide, etc., as well as combinations thereof. The particles may also be formed using a fumed process, precipitation, etc. Due to their higher surface area and smaller particle size, fumed particles (e.g., fumed silica particles) are particularly suitable for use in the present invention. When employed, the inorganic oxide particles typically constitute from about 0.01 wt. % to about 3 wt. %, in some embodiments from about 0.02 wt. % to about 2 wt. %, and in some embodiments, from about 0.05 wt. % to about 1 wt. % of the mixture.

Once charged into the vessel, the components (e.g., polyarylene sulfide and other optional additives) may be heated to a certain temperature to form a mixture. The temperature is generally selected to be lower than the melting temperature of the polyarylene sulfide, yet higher than the melting temperature of the impact modifier. The melting temperature of the polyarylene sulfide is typically from about 275° C. to about 350° C., and in some embodiments, from about 280° C. to about 300° C., while the melting temperature of the impact modifier is typically from about 70° C. to about 150° C., and in some embodiments, from about 80° C. to about 120° C. Thus, in certain embodiments, the heating temperature may be from about 150° C. to about 275° C., in some embodiments, from about 200° C. to about 270° C., and in some embodiments, from about 250° C. to about 270° C. Heating may be conducted in one or multiple steps for a total time period of from about 1 to about 120 minutes, in some embodiments from about 5 to about 100 minutes, and in some embodiments, from about 10 to about 60 minutes. If desired, an additional solvent (e.g., water) may also be charged into the vessel during the heating process to ensure that the total amount of solvent is sufficient to achieve the desired mixture. In certain cases, heating may be conducted at a temperature that is above the atmospheric pressure boiling point of a solvent in the mixture. NMP, for instance, has a boiling point at atmospheric pressure of about 203° C. In such embodiments, the heating is typically conducted under a relatively high pressure, such as above 1 atm, in some embodiments above about 2 atm, and in some embodiments, from about 3 to about 10 atm.

Upon formation of the mixture, it is thereafter subjected to a cooling cycle that may include one or multiple steps. Although not required in all cases, the present inventors have discovered that the use of a relatively slow cooling rate during the cooling cycle can significantly enhance the ability to form microparticles of the desired small size and narrow distribution. For example, the mixture may be cooled at a rate of about 3° C./min or less, in some embodiments about 2° C./min or less, and in some embodiments, from about 0.1 to about 1° C./min during at least a portion of the cooling cycle, if not over the course the entire cooling cycle. Such gradual cooling may occur, for instance, for a time period of from about 50 to about 800 minutes, in some embodiments from about 100 to about 600 minutes, and in some embodiments, from about 200 to about 300 minutes. In yet other embodiments, however, a rapid cooling step may be employed. For example, the mixture may be initially heated under pressure within a first vessel, such as described above. Thereafter, the heated and pressurized mixture can be released into a second vessel, which is maintained at a reduced pressure that is sufficiently low (e.g., at atmospheric pressure) so that the boiling point of a solvent in the mixture (e.g., NMP) is below the actual temperature of the heated mixture within the first vessel. This results in a rapid reduction in the temperature of the mixture as it enters the second vessel, and thus causes precipitation of microparticles therefrom.

Regardless of the technique employed, the resulting cooled slurry can be filtered and washed (e.g., with water or other solvent) to remove the solvent. The washed powder may then optionally be dried, typically at a temperature that is less than the melting temperature of the polyarylene sulfide to inhibit fusion or agglomeration of the powder. For example, drying may occur at a temperature of from about 20° C. to about 160° C., in some embodiments from about 30° C. to about 120° C., and in some embodiments, from about 40° C. to about 80° C.

The resulting powder thus contains a plurality of microparticles, which include the polyarylene sulfide along with various other optional components as noted above. When a blend of components is employed, the additive(s) typically constitute from about 1 to about 50 parts, in some embodiments from about 2 to about 40 parts, and in some embodiments, from about 5 to about 30 parts per hundred of the polyarylene sulfides. For instance, polyarylene sulfides may constitute from about 50 wt. % to about 99 wt. %, in some embodiments from about 60 wt. % to about 98 wt. %, and in some embodiments, from about 70 wt. % to about 90 wt. % of the microparticles. The additive(s) may likewise constitute from about 1 wt. % to about 45 wt. %, in some embodiments from about 2 wt. % to about 35 wt. %, and in some embodiments, from about 5 wt. % to about 25 wt. % of the microparticles. In certain embodiments, as noted above, inorganic oxide particles (e.g., fumed silica) may be employed during formation of the powder and remain present in the microparticles. For example, when employed, such inorganic oxide particles may constitute from about 0.05 wt. % to about 5 wt. %, in some embodiments from about 0.1 wt. % to about 3 wt. %, and in some embodiments, from about 0.2 wt. % to about 2 wt. % of the microparticles.

### II. Three-Dimensional Printing

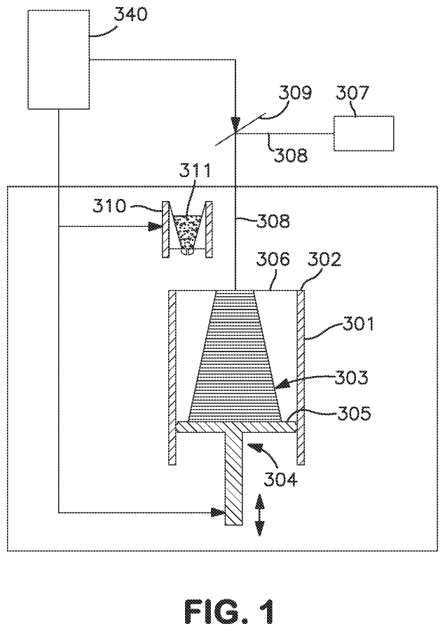

As noted above, the unique properties of the powder are particularly well-suited for forming three-dimensional structures by powder bed fusion. Generally speaking, powder bed fusion involves selectively fusing the powder within a powder bed to form the three-dimensional structure. The fusion process may be initiated by an energy source, such as a laser beam (e.g., laser sintering), electron beam, acoustic energy, thermal energy, etc. Examples of such systems are described, for instance, in U.S. Pat. Nos. 4,863,538; 5,132,143; 5,204,055; 8,221,858; and 9,895,842. Referring to FIG. 1, for example, one embodiment of a lasering sintering system is shown. As shown, the system includes a powder bed 301 for forming a three-dimensional structure 303. More particularly, the powder bed 301 has a substrate 305 from which extends sidewalls 302 that together define an opening. During operation, a powder supply 311 is deposited on the substrate 305 in a plurality of layers to form a build material. A frame 304 is moveable in a vertical direction (e.g., parallel to the sidewall of the powder bed 301) to position the substrate 305 in the desired location. A printer head 310 is also provided to deposit the powder supply 311 onto the substrate 305. The printer head 310 and powder bed 301 may both be provided within a machine frame 301. After the powder supply is deposited, an irradiation device 307 (e.g., laser) emits a light beam 308 onto a work plane 306. This light beam 308 is directed as deflected beam 308′ towards the work plane 306 by a deflection device 309, such as a rotating mirror. Thus, the powder supply 311 may be deposited layer-by-layer onto the working surface 305 or a previously fused layer, and thereafter fused at the positions of each powder layer corresponding by the laser beam 8′. After each selective fusion of a layer, the frame 304 may be lowered by a distance corresponding to the thickness of the powder layer to be subsequently applied. If desired, a control system 340 may also be employed to control the formation of the three-dimensional structure on the working surface 305. The control system 305 may include a distributed control system or any computer-based workstation that is fully or partially automated. For example, the control system 340 may be any device employing a general-purpose computer or an application-specific device, which may generally include processing devices (e.g., microprocessor), memory (e.g., CAD designs), and/or memory circuitry for storing one or more instructions for controlling operation of the printer head 310, powder bed 301, frame 304, and/or deflection device 309. The computer may include computer-based hardware, such as data storage devices, processors, memory modules, and the like for generating and storing tool path and related printing instructions. The computer may transmit these instructions to the control system to perform operations so that the three-dimensional structure are selectively formed.

The following test methods may be employed to determine certain of the properties described herein.

### Test Methods

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2013. Under the DSC procedure, samples were heated and cooled at 20° C. per minute as stated in ISO Standard 10350 using DSC measurements conducted on a TA Q2000 Instrument.

Melt Viscosity: The melt viscosity (Pa-s) may be determined in accordance with ISO Test No. 11443:2005 at a shear rate of 1,200 s⁻¹ using a Dynisco 7001 capillary rheometer. The rheometer orifice (die) may have a diameter of 1 mm, a length of 20 mm, an L/D ratio of 20.1, and an entrance angle of 180°. The diameter of the barrel may be 9.55 mm+0.005 mm and the length of the rod was 233.4 mm. The melt viscosity is typically determined at a temperature at least 15° C. above the melting temperature, such as 316° C.

Molecular Weight: The samples may be analyzed using a Polymer Labs GPC-220 size exclusion chromatograph. The instrument may be controlled by Precision Detector software installed on a Dell computer system. The analysis of the light scattering data may be performed using the Precision Detector software and the conventional GPC analysis was done using Polymer Labs Cirrus software. The GPC-220 may contain three Polymer Labs PLgel 10 μm MIXED-B columns running chloronaphthalene as the solvent at a flow rate of 1 ml/min at 220° C. The GPC may contain three detectors: Precision Detector PD2040 (static light scattering); Viscotek 220 Differential Viscometer; and a Polymer Labs refractometer. For analysis of the molecular weight and molecular weight distribution using the RI signal, the instrument may be calibrated using a set of polystyrene standards and plotting a calibration curve.

Particle Size Distribution: Particle size analysis may be carried out via laser diffraction as is known in the art. Before analysis, a water basin may be cleaned out thoroughly before running new samples. The instrument may be allowed to auto rinse for a couple of minutes. A “standard operating method” may be set up pertaining to each sample being tested. More particularly, PIDS (Polarization Intensity Differential Scattering) may be activated to calculate particle sizes from 0.017 μm to 2,000 μm. Sample name, density, and refractive index may be entered (refractive index of water is taken into account). Instrument alignment and offsets may be measured. A background may be run with every sample (if background is too large, the system may be cleaned). The sample may be loaded into the water basin (small amount of a neutral dispersant can be used if the sample did not mix well into the water basin). Results may be collected after the method completes three (3) 90-second runs. Of the three runs, the largest distribution may be selected as the particle size (largest size case scenario). If there is a large discrepancy or inconsistent trend between the runs, the sample may be run again to verify previous results.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A three-dimensional printing method comprising selectively fusing a powder within a powder bed, wherein the powder comprises a plurality of polyarylene sulfide microparticles having a volume-based median particle size of from about 0.5 to about 200 micrometers.

2. The method of claim 1, wherein the polyarylene sulfide is a linear polyphenylene sulfide.

3. The method of claim 1, wherein at least 90% by volume of the microparticles have a size of from about 0.5 to about 200 micrometers.

4. The method of claim 1, wherein the microparticles have an aspect ratio of from about 0.7 to about 1.3.

5. The method of claim 1, wherein the microparticles are selectively fused using thermal energy.

6. The method of claim 1, wherein the microparticles are selectively fused using a laser.

7. The method of claim 1, wherein the microparticles are selectively fused using an electron beam.

8. The method of claim 1, wherein the powder is selectively fused at a temperature from about 225° C. to about 280° C.

9. A three-dimensional printing system comprising:
a powder supply comprising a plurality of polyarylene sulfide microparticles having a volume-based median particle size of from about 0.5 to about 200 micrometers;
a powder bed configured to receive the powder supply; and
an energy source for selectively fusing the powder supply when present within the powder bed.

10. The system of claim 9, wherein at least 90% by volume of the microparticles have a size of from about 0.5 to about 200 micrometers.

11. The system of claim 9, wherein the microparticles have an aspect ratio of from about 0.7 to about 1.3.
